(19) United States
(12) Patent Application Publication
(10) Pub. No.: US 2010/0038025 A1
(43) Pub. Date: Feb. 18, 2010

(54) INTRINSICALLY HEATABLE HOT MELT ADHESIVE SHEET MATERIALS

(76) Inventors: Klaus Keite-Telgen-Büscher, Hamburg (DE); Christina Hirt, Wurzburg (DE); Jara Fernán-Dez-Pastor, Gijon Asturias (DE)

Correspondence Address: Briscoe, Kurt G.;Norris McLaughlin & Marcus, PA, 875 Third Avenue, 8th Floor, New York, NY, 10022, US

(21) Appl. No.: 12/526,806

(22) PCT Filed: Feb. 1, 2008
(86) PCT No.: PCT/EP08/51250

§ 371 Date: Oct. 27, 2009

(30) Foreign Application Priority Data
Feb. 13, 2007 (DE) 10 2007 007 617.9

(51) Int. Cl. B32B 38/00; B32B 7/12; B32B 5/00; B32B 27/00

(52) U.S. Cl. 156/272.2; 428/347; 428/332; 428/349

(57) ABSTRACT

The invention relates to sheet materials, having at least one layer of an adhesive mass, within which heat can be produced, wherein the adhesive mass is a hot melt adhesive mass and a PTC resistor.

The invention relates to planar structures composed of at least one layer of hotmelt adhesive, and to their use.

Within the automobile industry the use of electrically heatable exterior mirrors is increasing. Heated seats as well are more and more widespread. In order to achieve the desired heating in such applications, in the simplest case, resistor wires are laid in a planar fashion. The heating output in this case is constant and is controlled via an external mechanism. In recent years the use of what are called PTC elements (PTC for “positive temperature coefficient”) has become established.

The PTC effect is exhibited by current-conducting materials which are better able to conduct the current at lower temperatures than at higher temperatures. Materials of this kind are also referred to as posistors; the materials, accordingly, exhibit posistor behavior.

For instance, for exterior automobile mirrors, PTC elements contacted with aluminum conductor tracks, for example, are adhesively bonded. PTC elements are elements which present a resistance to a high current. As a result of a defined current strength being applied, the PTC element heats up and the heat is transferred via a double-sided pressure-sensitive adhesive tape to the glass surface of the mirror. The PTC effect limits the temperature attained, since with increasing temperature there is a rise in the resistance of the heating element and hence a reduction in current flow. In this way it is possible to obtain temperatures of 45 to 80° C. on the surface. PTC materials used are generally carbon-black-filled, partially crystalline thermoplastics, examples being polyethylene, polyvinylidene fluoride, hexafluoro-propylene or tetrafluoroethylene. The state of the art is described in detail in DE 29 48 350 A1, EP 0 307 205 A1, EP 0 512 703 A1, and EP 0 852 801 A1. In the mirror heating utility, these PTC materials, in the form of an ink, are printed onto a network of conductor tracks which serve for contacting. The solvent contained in the ink is dried off. Inks of this kind are described at length in EP 0 435 923 A1.

The PTC element is fixed to the mirror plate using, in general, pressure-sensitive adhesive tapes. Besides a very high thermal conductivity, other particular requirements are imposed on the pressure-sensitive adhesive tape that transports the heat from the PTC element to the mirror's surface, in respect of thermal shear strength at elevated temperatures, weathering stability, and adhesive tack at low temperatures.

The existing concept functions well but requires a relatively complicated construction, since the PTC elements must be bonded not only to the glass of the mirror but also to the support plate of the mirror, which in many cases is composed of the plastic acrylonitrile/butadiene/styrene (ABS). The bonding of these different materials likewise places particular requirements on the adhesive tape.

Also known, from DE 103 10 722 A1, is a pressure-sensitive adhesive planar structure which is intrinsically heatable and which combines the heating function with the adhesive tack. Disadvantageous features, however, are the sharply decreasing adhesive tack with increasing fraction of heat-generating components in the pressure-sensitive adhesive, and also the difficulties of attaining a sufficient PTC effect with the pressure-sensitive adhesive polymers, which in general are amorphous.

To simplify the operation of manufacturing heatable mirrors, therefore, there is a need for an improved, heatable, self-regulating adhesive tape which bonds the support plate to the mirror and which, moreover, generates heat in itself by means for example of electrical current or of another physical process.

This object is achieved, surprisingly and in a way unforeseeable for the skilled worker, by a planar structure comprising at least one layer within which heat can be generated, this layer being hotmelt-adhesive and having posistor behavior, i.e., exhibiting the PTC effect.

The dependent claims relate to preferred developments of this planar structure and also to its use.

The heat is generated within the hotmelt-adhesive layer preferably by the electrical resistance. In accordance with the invention it is possible for such planar structures to be used singularly or multiply, and the heat generation process may also be amiable to single or reproducible implementation.

The generation of heat in the hotmelt-adhesive layer is limited by the PTC effect, and so the layer is self-regulating in terms of giving off heat, particularly with regard to a maximum temperature value that cannot be exceeded. The intention is therefore that overheating of the planar structure shall be avoided.

In one simple embodiment the planar structure is composed of a singular ply of a heat-generating hotmelt adhesive which joins, for example, mirror and support plate. The contacting means necessary for electrical resistance heating is then accommodated in a separate element, which may also be the mirror or the mirror support plate.

In a second, preferred embodiment, the contacting means is an integral constituent of the planar structure.

Hotmelt Adhesives

An important constituent of the planar structure of the invention (hotmelt adhesive tape) is the heatable hotmelt adhesive.

A planar structure of the invention is hotmelt-adhesive in the sense of the present invention if, after application in melt form to the adhesion base, and subsequent cooling, the bond strength at room temperature in accordance with ASTM D 3330-04 (at a peel speed of 300 mm/min on the adhesion base to which bonding is to take place) is greater than 1 N/cm, preferably greater than 3 N/cm, more preferably greater than 5 N/cm.

It is possible with advantage to use hotmelt adhesives of a kind which comprise

(a) at least one adhesive component and

(b) at least one electrically conductive material (“filler material”).

In the case of a hotmelt adhesive which is, consequently, electrically heatable, an advantageous feature is the addition of at least one electrically conductive filler material which develops heat when acted on by current. In one preferred embodiment, graphites or carbon blacks can be used. In one further-preferred embodiment, this filler is nanoscale: that is, it possesses an extent in at least one spatial dimension of not more than 500 nm, preferably not more than 200 nm, more preferably not more than 50 nm. One very preferred embodiment uses conductive carbon black (for example, Printex® XE from Degussa). In a further very preferred embodiment, carbon nanotubes (for example, from Ahwahnee, or carbon nanotube masterbatches from Hyperion Catalysis) and/or carbon nanofibers are used. The small fraction of filler that is needed for heating is an advantage here, meaning that there is little effect on the mechanical properties of the hotmelt adhesive.

The extent of the effect of the electrical heatability of the hotmelt adhesive can be determined by the degree of filling, in other words the mass fraction of the filler material in the hotmelt adhesive. The degree of filling is advantageously between 1% and 60% by weight. With great preference, between 5% and 50% by weight of filler material is used.

The conductivity and hence also the attainable temperature and heating rate is dependent on factors including the degree of filling. By raising the degree of filling it is possible to achieve higher conductivities and possibly also higher temperatures. Moreover, the electrical conductivity and hence the heatability of the hotmelt adhesive is also dependent on the base polymer of the adhesive component.

A further improvement in the backing material can be achieved through the addition of at least one filler having a high heat capacity, in particular with a heat capacity of more than 0.7 J/gK. As a result of the buffer function, this leads to an evening-out of the heating behavior and to a prolonged delivery of heat after the end of the active heat generation process.

Examples of fillers with a high heat capacity that can be used advantageously in accordance with the invention include aluminum, beryllium, boron, calcium, iron, graphite, potassium, copper, magnesium, phosphorus or compounds of the aforementioned substances, especially aluminum oxide and aluminum chloride, calcium carbonate, calcium chloride, copper sulfate, magnetite, hematite, magnesium carbonate and magnesium chloride, phosphorus chloride, and phosphorus oxide.

As an adhesive component of the electrically heatable hotmelt adhesives it is possible outstandingly to use all polymers having suitable hotmelt-adhesive properties which, together with the electrically conducting filler material, exhibit a PTC effect—that is, have posistor behavior. It is preferred to use multiphase systems, more particularly those in which at least one phase responds to the heating, in the temperature range at which the PTC effect occurs, by undergoing a volume expansion which, according to generally recognized scientific explanation, is at least part of the cause of the PTC effect (see J. Meyer in Polymer Engineering and Science, 13 (1973), pp. 462-468). Multiphase systems in the sense of the invention include polymers and polymer blends filled with a further filler.

Particular preference is given to using partially crystalline polymers or block copolymers. Partially crystalline systems used may include both single-phase and multiphase systems. The hotmelt adhesive preferably contains at least 30% by weight of partially crystalline polymers; even better is a fraction of partially crystalline polymers of at least 50% by weight in the hotmelt adhesive. It has emerged that the suitability for obtaining the PTC effect is surprisingly sharply improved in line with the fraction of partially crystalline systems, as compared with pressure-sensitive adhesives, which lose their adhesive properties as the partially crystalline fraction goes up and which therefore contain only relatively low fractions of partially crystalline systems. Hotmelt adhesives are therefore suitable beyond expectations for the application of the PTC effect.

Partially crystalline polymers or block copolymers which have emerged as being particularly advantageous in the inventive sense are those which are present at 100% in the adhesive or which are present almost at 100% in the adhesive.

Particular preference is given to using those partially crystalline polymers for which the degree of crystallinity, as determined by differential scanning calorimetry (DSC), is preferably more than 20%, more preferably more than 40%.

Very particular preference in the field of partially crystalline thermoplastics is given to using polyolefins (e.g., low-density polyethylene) or copolymers of polyolefins (e.g., ethylene-vinyl acetate (EVA), ethylene-acrylic acid (EAA), ethylene-methacrylic acid (EMAA), ethylene-ethyl acrylate, ethylene-butyl acrylate), ionomers, polyamides and/or their copolymers. In addition to a sufficient PTC effect, these systems also exhibit particularly good hotmelt adhesive properties.

Additionally preferred in the field of partially crystalline thermoplastics are acid-modified (modified, for example, with maleic acid or maleic anhydride) polyolefins or their copolymers, since these are especially compatible with the conductive fillers (e.g., carbon black or carbon nanotubes) and it is therefore easier to prepare homogeneous dispersions of the filler in the polymer matrix.

Very particular preference is given as block copolymers to styrene block copolymers, such as, for example, SBS (styrene/butadiene/styrene block copolymers), SIS (styrene/isoprene/styrene block copolymers), SEBS (styrene-ethylene-butylene-styrene block copolymers) or SEPS (styrene-ethylene-propylene-styrene block copolymers).

In order to optimize the technical adhesive properties it is possible advantageously to admix resins to the inventive hotmelt adhesives. As tackifying resins for addition it is possible without exception to use all existing tackifier resins described in the literature. Representatives that may be mentioned include pinene resins, indene resins, and rosins, their dispro-portionated, hydrated, polymerized, and esterified derivatives and salts, the aliphatic and aromatic hydrocarbon resins, terpene resins and terpene-phenolic resins, and also C₅ to C₉ resins and other hydrocarbon resins. Any desired combinations of these and further resins may be used in order to adjust the properties of the resultant adhesive in accordance with what is desired. Generally speaking it is possible to employ any resins which are compatible (soluble) with the thermoplastic in question; in particular, reference may be made to all aliphatic, aromatic, and alkylaromatic hydrocarbon resins, hydrocarbon resins based on pure monomers, hydrated hydrocarbon resins, functional hydrocarbon resins, and natural resins. One preferred version uses resins which, even over a prolonged period of time, do not reduce the electrical conductivity and the heatability.

The hotmelt adhesives used for the inventive planar structures are preferably crosslinked, the aim being for high degrees of crosslinking, which in particular also assist the PTC effect (see EP 0 311 142 A1 or U.S. Pat. No. 4,775,778 A). Crosslinking also eliminates or attenuates the NTC effect (negative temperature coefficient), which is observed at temperatures above the melting point of the adhesive. According to one preferred embodiment of the invention, the at least one adhesive component preferably has a degree of crosslinking which corresponds at least to a gel index of 35%, in particular of at least 60%. This gel index is defined as the ratio of adhesive component that is insoluble in a suitable solvent (e.g., toluene or xylene) to the sum of soluble and insoluble component. In one preferred procedure the hotmelt adhesives are crosslinked using electron beams. Typical irradiation equipment which can be employed includes linear cathode systems, scanner systems, and segmented cathode systems, where electron beam accelerators are concerned. A lengthy description of the state of the art and the most important process parameters are found in Skelhorne, Electron Beam Processing, in Chemistry and Technology of UV and EB formulation for Coatings, Inks and Paints, vol. 1, 1991, SITA, London. Typical acceleration voltages are situated in the range between 50 and 500 kV, preferably in the range between 80 and 300 kV. The scattered doses employed range between 5 to 150 kGy, in particular between 20 and 100 kGy. It is also possible to employ other processes which allow high-energy irradiation.

A further constituent of the invention is the method in which a variation is produced in the electrical conductivity and hence in the thermal heating via the degree of crosslinking. By raising the EB dose (and hence also the degree of crosslinking) it is possible to increase the electrical conductivity, and, for a given current, the temperature of the hotmelt adhesive goes up. Via the degree of crosslinking it is likewise possible to adjust the PTC effect.

In order to reduce the required dose it is possible to admix the hotmelt adhesive with crosslinkers and/or crosslinking promoters, specifically promoters and/or crosslinkers which are excitable by electron beams or thermally. Suitable crosslinkers for electron beam crosslinking are, for example, difunctional or polyfunctional acrylates or methacrylates, but also triallyl cyanurates and triallyl isocyanurates. In a further preferred version the hotmelt adhesives are crosslinked with thermally activatable crosslinkers. For this purpose it is preferred to admix difunctional or polyfunctional epoxides, difunctional or polyfunctional hydroxides, and also difunctional or polyfunctional isocyanates or silanes.

In addition it is possible advantageously to add plasticizers to the hotmelt adhesive for the purpose of improving the adhesiveness.

Also advantageous is the addition of polymeric or inorganic fillers which, with their melting in the course of heating, assist the PTC effect. These fillers may be, for example, polyolefin waxes of high crystallinity or ionic liquids (low-melting metal salts). Through the choice of the melting point of the fillers it is possible, moreover, to adjust the temperature at which the PTC effect occurs.

Preparation Process for the Hotmelt Adhesives

The electrically conductive filler materials can be admixed to the monomers before the polymerization and/or during the polymerization and/or to the polymers after the end of the polymerization. Preferably the filler material is compounded after the polymerization into a melt of the at least one adhesive component.

For coating from the melt, as a hotmelt system, the electrically conductive filler material is preferably compounded into the melt. In this case, homogeneous incorporation is desirable in the sense of the invention. Homogeneous distributions of the filler material in the hotmelt adhesive are achieved preferably by compounding in twin screw extruders or planetary roller extruders.

An advantage of this procedure is the very short contamination of the preparation procedure with the filler material, and also the avoidance of solvents.

Production of Hotmelt Adhesive Tapes

The planar structure of the invention can be produced with the commonplace methods of producing polymeric films in accordance with the prior art. These include, for example, flat film extrusion, blown film extrusion, the calender method, and coating from a solution or from a monomeric or prepolymeric precursor of the polymer.

The planar structure may advantageously have a thickness of up to 1000 μm. In accordance with one particularly advantageous embodiment of the invention said thickness is 10 to 400 μm, especially 30 to 200 μm.

Orientations introduced within the polymer as a result of the production operation (particularly the incorporation of anisotropic properties with respect to physical properties and/or with respect to the orientation of the macromolecules) may assist the PTC effect.

One advantageous embodiment of the invention concerns planar structures of the invention, particularly of the kind set out in the passages of text above (with particular advantage in the form of electrically heatable hotmelt adhesive tapes), which comprise a film of a heatable hotmelt adhesive and an electrically conductive contacting means.

Contacting means that are suitable advantageously are metal foils, metal meshes or metal-coated polymeric films, papers or nonwovens.

In one simple case the heatable hotmelt adhesive is contacted with an electrically conductive metal. It is preferred to employ metals which exhibit little or no corrosion over prolonged periods of time. In very preferred versions, for example, copper or aluminum is used, although silver or gold contacting means may also be implemented. The metal may be deposited directly on the hotmelt adhesive, for example, by means of electroplating or vapor deposition methods, or may be laminated on in the form of a continuous or perforated layer. Also possible is the use of a conductive varnish or a conductive liquid ink or printing ink. FIGS. 1 to 7 show by way of example typical product constructions of the planar structures of the invention.

FIG. 1: contacting via Al foil

FIG. 2: contacting via Al foil and metal mesh

FIG. 3: contacting via metalized film

FIG. 4: hotmelt adhesive with whole-area contacting: (a) cross section, (b) plane view

FIG. 5: adhesive contacted on one side with a comb structure: (a) cross section, (b) plane view

FIG. 6: multilayer planar structure of the invention

FIG. 7: planar structure of the invention with two-ply construction of the heatable hotmelt adhesive and with planar contacting

Possible arrangements of such contacted hotmelt adhesive tapes are depicted in FIGS. 1 to 5. According to FIG. 1 the electrically heatable hotmelt adhesive 10 is contacted on both sides and over its full area with a metal foil 12, in particular an aluminum or copper foil. According to FIG. 2 the hotmelt adhesive 10 is contacted on one side, likewise over its full area, with a metal foil 12, and on the other side, over part of its area, with a metal mesh 14. FIG. 3, finally, shows a product construction in which the hotmelt adhesive 10 is contacted on both sides with a metalized polymeric film, 16 referring in each case to the polymeric film and 18 to its metal coating.

The contacting means may extend on both sides over the whole area of the adhesive tape surface, or may cover the surface on one or both sides only partially, in particular in the form of lines, dots, grids, combs or other geometric shapes. In the former case the result is a flow of current transverse to the two-dimensional extent of the heatable hotmelt adhesive (z direction), whereas in the second case the result, exclusively or additionally, is a flow of current within the two-dimensional extent of the heatable hotmelt adhesive (x-y direction). FIGS. 4 and 5 illustrate such versions exemplarily and without any desire to restrict the invention unnecessarily.

Key: 10=heatable hotmelt adhesive, 12=metal foil, 20=electrode structure

Further advantageous product designs are realizable. One particularly advantageous construction of the backing material comprises, in addition to the heatable hotmelt adhesive, further hotmelt adhesive layers and/or pressure-sensitive adhesive layers and contacting layers, and also lining materials (cf. one example of such a planar structure in FIG. 6; key: 10=heatable hotmelt adhesive, 12=metal foil, 22=pressure-sensitive adhesive, 24=siliconized PET film).

In one advantageous embodiment the hotmelt-adhesive planar structure of the invention comprises a layer of a pressure-sensitive adhesive. This layer may be laminated on or applied from solution, dispersion or melt to the hotmelt-adhesive planar structure of the invention. The latter then functions as a backing material for the pressure-sensitive adhesive, so producing a pressure-sensitive adhesive tape which is pressure-sensitively adhesive on one side and hotmelt-adhesive on the other, but which, advantageously, does without a separate backing material (as depicted in EP 1111021 B1, for example). The construction of an advantageous adhesive tape of this kind with a layer of pressure-sensitive adhesive is shown by FIG. 17.

Embodiments of the planar structure of the invention may also be realized with a separate backing material. In that case it is particularly advantageous for the backing material to have a high thermal conductivity, more particularly of at least 0.5 W/m·K, very preferably of more than 1 W/m·K. Particularly preferred materials are polymers filled with thermally conductive fillers, such as boron nitride or aluminum oxide, for example. The construction of one such advantageous adhesive tape with a backing material is shown by FIG. 18.

Pressure-sensitive adhesives (PSAs) which can be used are all of the adhesives known to the skilled worker, advantageously those based on acrylic acid and/or methacrylic acid and/or based on esters of the aforementioned compounds, or one based on hydrated natural or synthetic rubbers, since these are particularly stable to aging and therefore withstand repeated heating operations on the planar structure of the invention over the long term.

It is particularly advantageous to use PSAs which themselves have a high thermal conductivity, especially of at least 0.5 W/m·K, very preferably of more than 1 W/m·K. Particularly preferred materials are PSAs filled with thermally conductive fillers, such as boron nitride or aluminum oxide, for example.

Additionally the PSA may be covered with a release liner material. Examples of suitable liner materials include all siliconized or fluorinated films having a release effect. Film materials that may be mentioned here, merely by way of example, include PP (polypropylene), BOPP (biaxially oriented PP), MOPP (monoaxially oriented PP), PET (polyethylene tere-phthalate), PVC (polyvinyl chloride), PU (poly-urethane), PE (polyethylene), PE/EVA (polyethylene/ethylene-vinyl acetate copolymers), and EPDM (ethene/propylene-diene terpolymers). Additionally it is also possible to use release papers (glassine papers, kraft papers, polyolefinically coated papers). The construction of one such advantageous adhesive tape with a liner material is shown by FIG. 19.

It is particularly advantageous to use liner materials which themselves have a high thermal conductivity, especially of at least 0.5 W/m·K, very preferably of more than 1 W/m·K. Particularly preferred materials are polymers filled with thermally conductive fillers, such as boron nitride or aluminum oxide, for example.

By means of particularly thermally conductive PSAs, backing materials and/or liner materials it is possible to introduce more effectively the energy needed to melt the hotmelt adhesive, and this results, for example, in shortened cycle times in application.

In one preferred embodiment the hotmelt-adhesive, heatable layer is composed of two or more plies of the same or similar materials. Particularly in the case of heating by electrical resistance in the z direction, possible short circuits as a result of agglomerates of filler are avoided by this means. FIG. 7 depicts one such construction with two-ply heatable hotmelt adhesive. The plies may be durably joined to one another by heat sealing.

Key: 10=heatable hotmelt adhesive, 12=metal foil

In a further advantageous embodiment the heatable planar structure is equipped with a mechanism which when the planar structure is first heated leads to an increase in the cohesion of the hotmelt-adhesive, heatable layer and/or of a further hotmelt adhesive layer or pressure-sensitive adhesive layer. This could be, for example, an increase in the crosslinking density as a result of thermally initiated postcrosslinking, which is initiated in particular by the heating of the planar structure itself. A planar structure of this kind is advantageously used such that, first of all, the adhesive bond is produced to at least one substrate, then the initial heating is performed, and accordingly the bond becomes solid.

The planar structure of the invention exhibits a high heating performance and is suitable for use as a hotmelt adhesive tape which in addition to an adhesive bonding function also fulfills a heating function, such as for the adhesive bonding of heatable mirrors.

Accordingly the invention provides for the use of the afore-described planar structures for adhesively bonding substrates in the automobile industry, and also its use for heating substrates bonded with such planar structures, especially in the automobile industry.

In the case of one advantageous use of the planar structures of the invention, the heating of the substrate is induced by heating of the planar structure, the planar structure having been applied to at least one base surface which is equipped with at least one electrical contact, the base surface in particular being one of the adhesively bonded substrates itself (but not necessarily so).

The latter use is also suitable, in particular, for those embodiments of the planar structures of the invention in which an electrical contact has not been integrated into the planar structure itself.

Experiments

The invention is described below by means of experiments, without wishing to subject the invention to any unnecessary restriction as a result of the choice of samples investigated.

Test methods employed were as follows.

T-Peel Force Test (Test A)

To determine the bond strength of the backing materials, a strip of the planar structure of the invention, 200 μm thick, was sealed to an untreated polyester film (Mitsubishi Hostaphan) by means of a heating press under vacuum at a temperature of 140° C. From this a strip 20 mm wide was cut, and, after 24 h of conditioning under ambient conditions, the heating sheet was removed again from the polyester backing and a measurement was made of the force. For this measurement, neither heating sheet nor polyester film were supported or fixed, and so the peel that occurred was T-shaped. The results are reported in N/cm and have been averaged from three measurements. All of the measurements were carried out at room temperature under climatically controlled conditions.

Measurement of the Heatability and of the PTC Effect (Test B)

To determine the electrical heatability of the material, a measurement was made of the temperature increase after subjection to electrical voltage. The temperature was measured using a Pt100 heat sensor. Contacting was carried out in accordance with FIG. 1 by providing (by hot lamination) a 200 μm film of the heatable hotmelt adhesive on both sides with a copper foil 50 μm thick that measured 40×80 mm², and a direct voltage of 12.8 volts was applied via a transformer and via these electrodes. The top side was positively charged, the bottom side negatively charged. The temperature was measured after 600 seconds directly on the surface of the copper foil, and was reported in ° C.

In order to determine the PTC effect, the temperature increase after subjection to a current was plotted over time for the same test specimens. The temperature was measured as above. Moreover, time plots of current and voltage were recorded, thus allowing the change in resistance to be calculated.

Measurement of the Heatability and of the PTC Effect (Test C)

The hotmelt-adhesive, heatable backing material was contacted on one side (by hot lamination) with a comb-shaped conductor structure located on a PET backing material, in the same way as in FIG. 5, and on the other side was applied to a glass plate by means of a film of pressure-sensitive adhesive (resin-modified acrylate PSA) 75 μm thick. The area of the electrode was 180 cm². Via this flexible conductor plate a direct voltage of 12.8 volts was applied by a transformer. The temperature was measured after 600 seconds directly on the surface of the copper foil and was expressed in ° C. To determine the PTC effect, furthermore, the temperature increase after current exposure was recorded over time on the same test specimens. Temperature is measured as above. Again, current and voltage were recorded over time, thus allowing the change in resistance to be calculated.

Production of the Samples

First of all the selected thermoplastics were compounded with the conductive fillers using a Haake Rheomix recording extruder. This operation was carried out using a temperature of 140° C. and a rotary speed of 120 min⁻¹ over a time of 45 minutes.

Using a vacuum press, planar structures with a thickness of 200 μm were produced from the polymer compounds.

The following specimens were produced:

TABLE 1
Prepared blends of the backing materials

| | | | | Fraction |
|---|---|---|---|---|
| | | | | of filler |
| | | Polymer | | [% by |
| | Polymer | Type | Filler type | weight] |
| Example | | | | |
| No. | | | | |
| 1 | ExxonMobil | EVA, 14% | Carbon black, | 10 |
| | Escorene | VA | Degussa Printex | |
| | Ultra | | XE2 | |
| | FL 00014 | | | |
| 2 | ExxonMobil | EVA | Hyperion Catalysis | 20 |
| | Escorene | | MB 2525-00 (EVA | |
| | Ultra | | masterbatch with | |
| | FL 00014 | | 25% carbon nano- | |
| | | | tubes) | |
| 3 | ExxonMobil | EVA 14% | Graphite, Timcal | 36 |
| | Escorene | VA | Timrex KS6 | |
| | Ultra | | | |
| | FL 00014 | | | |
| 4 | ExxonMobil | EVA, 14% | Carbon black, | 15 |
| | Escorene | VA | Degussa Printex | |
| | Ultra | | XE2 | |
| | FL 00014 | | | |
| 5 | ExxonMobil | EVA 14% | Graphite, Timcal | 45 |
| | Escorene | VA | Timrex KS6 | |
| | Ultra | | | |
| | FL 00014 | | | |
| 6 | Dow Primacor | EAA | Carbon black | 16 |
| | 3450 | | Printex XE2 | |
| Counter- | | | | |
| examples | | | | |
| 7 | Basell | HDPE | Carbon black | 12 |
| | Hostalen HS | | Printex XE2 | |
| | GC 7260 F2 | | | |
| 8 | ExxonMobil | HDPE | Carbon black | 11 |
| | HTA 108 | | Printex XE2 | |
| 9 | Pressure- | Poly- | Graphite, Timcal | 40 |
| | sensitive | acrylate | Timrex KS6 | |
| | adhesive | | | |
| | according to | | | |
| | example | | | |
| | “adhesive | | | |
| | component 1” | | | |
| | from | | | |
| | WO 2004/0811 | | | |
| | 36 A (cf. | | | |
| | page 20, | | | |
| | lines 3 to | | | |
| | 17) | | | |

EVA: ethylene-vinyl acetate copolymer
EAA: ethylene-acrylic acid copolymer
HDPE: low-pressure polyethylene (high density poly-ethylene)

The solvent was removed from the PSA prepared from example 9. The further preparation of the specimen was as described above. This specimen was subsequently crosslinked by electron bombardment in accordance with example 1 from WO 2004/081136. The dose here was 50 kGy with an acceleration voltage of 220 kV.

Results

To determine the heat-sealing strength, examples 1-5 were subjected to test A. It was not possible to carry out the test with examples 6 and 8, since they lacked heat-sealability and therefore did not adhere to the polyester film. These counter-examples show that the HDPE used commonly for electrical switching elements with a PTC effect (thermoswitches) does not have properties in accordance with the invention. It was therefore not possible to include these specimens in the following tests either. The measurement values are summarized in table 2.

TABLE 2
Peel forces according to test A

| Example | Peel force in [N/cm] |
|---|---|
| 1 | 3.5 |
| 2 | 4.0 |
| 3 | 2.2 |
| 4 | 3.1 |
| 5 | 1.6 |
| 6 | >10 (film torn) |

The values shown in table 2 illustrate the fact that examples 1 to 6 have good hotmelt-adhesive properties. The bond strength can be controlled through the amounts and type of the addition of filler material and also through the monomer/comonomer composition. High fractions of the filler material reduce the bond strength.

To determine the heatability and the PTC effect, test B was carried out. Since in this case the conduction took place in the z direction through the 200 μm thick planar structure, a low filler content was sufficient to produce sufficient conductivity, and so only specimens 1 to 3 were tested. In the case of the other specimens, the conductivity was too great, and so the voltage was regulated downward as a result of the current limitation of the network components.

FIG. 8 shows the current, voltage, and temperature profile in test B for specimen 1; calculated from this was the resistance/temperature plot in FIG. 9, which illustrates the PTC effect. FIG. 10 shows a PTC plot of this kind for specimen 2, FIG. 11 for specimen 3.

On the one hand it is apparent from these illustrations that the planar structures produce good heating, and, on the other hand, that there is a clear PTC effect. This can be achieved with different fillers.

To determine the heatability and the PTC effect, additionally, test C was carried out. In this case the more highly conductive specimens 4, 5, and 6 were used, since the distance between the conductor tracks was 1.5 mm.

FIG. 12 shows the current, voltage, and temperature profile in test C for specimen 4; calculated from this was the resistance/temperature plot in FIG. 13, which illustrates the PTC effect. FIG. 14 shows a PTC plot of this kind for specimen 5, FIG. 15 for specimen 6.

On the one hand it is apparent from these illustrations that in this contacting mode as well the planar structures produce good heating, and also, on the other hand, that there is a clear PTC effect here as well. This can be achieved with different fillers. It is likewise possible to exert control via the comonomer composition.

As a further comparative example, a PSA with PTC effect was investigated by means of test B (specimen 9). PSAs of this kind are described in WO 2004/081136 A1. The investigation shows that the PTC effect, which is found in the temperature range of from 22 to about 40° C., is very much less marked than in the case of the examples according to the invention. Furthermore, the heatable PSA exhibits an NTC effect (negative temperature coefficient) above 40° C., a phenomenon which in many applications is a disadvantage. As a result of the crosslinking, there is no melting of the PSA.

The skilled worker would have expected hotmelt adhesives not to be suitable for application for adhesion bonding in the automobile segment at least when the adhesive was configured as an (electrically) heatable adhesive and when this adhesive was to be used for heating substrates bonded with planar structures of this kind. In this respect, therefore, the skilled worker would have had to forgo the advantages which arise from adhesive bonding with hotmelt adhesives. As a result of the implementation of the PTC effect, success has been achieved in offering hotmelt adhesives which are self-regulating insofar as they present resistance to the heat-generating moment (in this case, the electrical current) when high values are reached. It is therefore possible to bring about a situation in which, inherent in the system, there is a maximum temperature which the temperature is unable to exceed in the course of the heating operation. It is therefore possible to prevent the hotmelt adhesives, as a result of the heating, entering the temperature range of the melting or softening temperature, with the adhesive bond running the risk of undergoing substantial deterioration or even of parting completely.

It is true that the application of the PTC temperature in PSAs was known from the prior art, but for PSA the problem of melting on “overheating” was not relevant. For hotmelt compositions, therefore, the problem was entirely different with regard to the profile of properties and the requirements. Furthermore, it has been possible to find a surprisingly high suitability of the hotmelt adhesives for the PTC effect, which could not have been inferred from the behavior in the case of pressure-sensitive adhesives.

### FIGURES

FIG. 1: contacting via Al foil

FIG. 2: contacting via Al foil and metal mesh

FIG. 3: contacting via metalized film

FIG. 4: hotmelt adhesive with whole-area contacting: (a) cross section, (b) plan view

FIG. 5: adhesive contacted on one side with a comb structure: (a) cross section, (b) plan view

FIG. 6: multilayer planar structure of the invention

FIG. 7: planar structure of the invention with two-ply construction of the heatable hotmelt adhesive and with planar contacting

FIG. 8: voltage, current, and temperature profile for example 1 in test B

FIG. 9: PTC effect for example 1 in test B

FIG. 10: PTC effect for example 2 in test B

FIG. 11: PTC effect for example 3 in test B

FIG. 12: voltage, current, and temperature profile for example 4 in test C

FIG. 13: PTC effect for example 4 in test C

FIG. 14: PTC effect for example 5 in test C

FIG. 15: PTC effect for example 6 in test C

FIG. 16: PTC effect for example 9 in test B

FIG. 17: multilayer planar structure of the invention with PSA layer

FIG. 18: multilayer planar structure of the invention with PSA layer and backing material

FIG. 19: multilayer planar structure of the invention with PSA layer and liner material

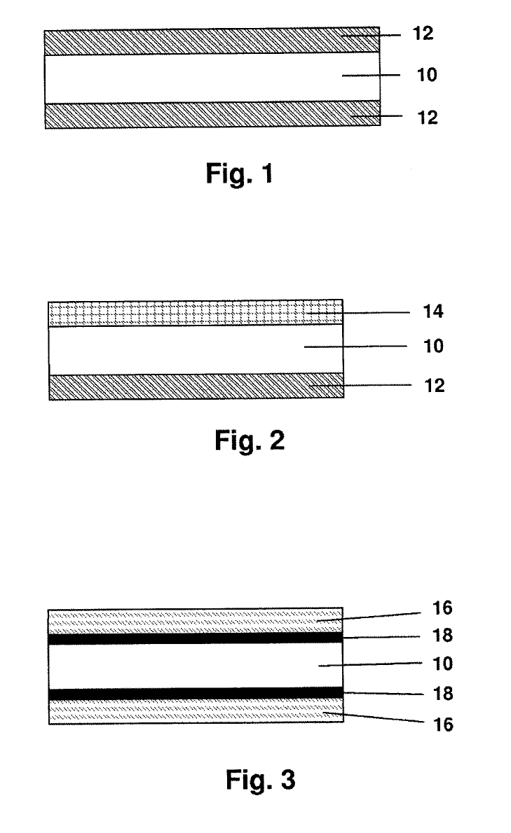

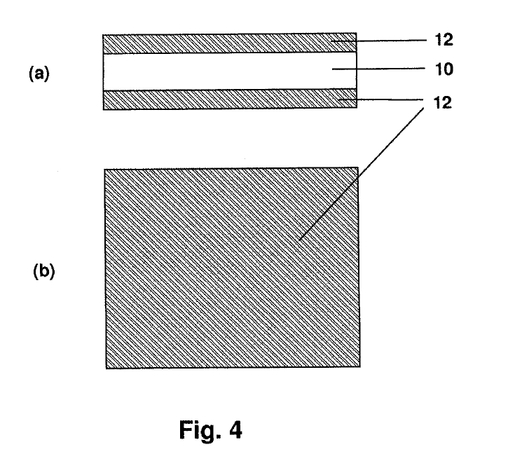

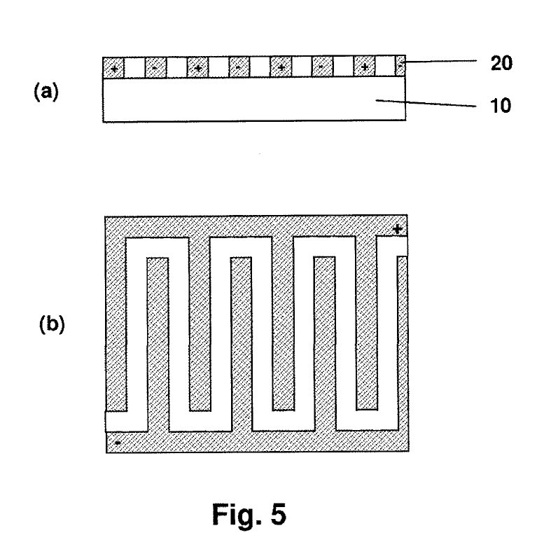

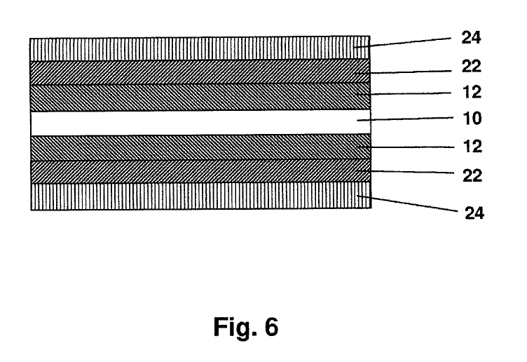

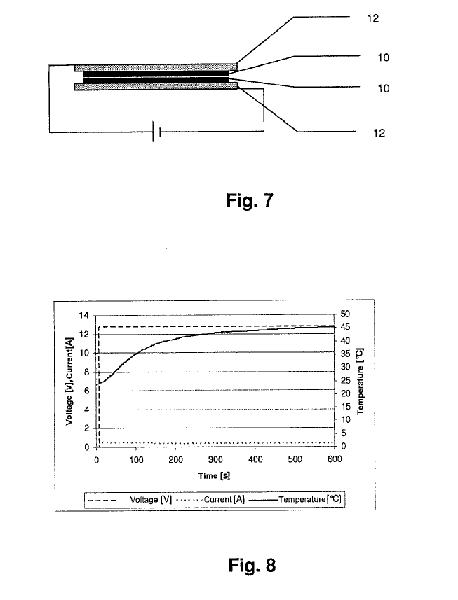

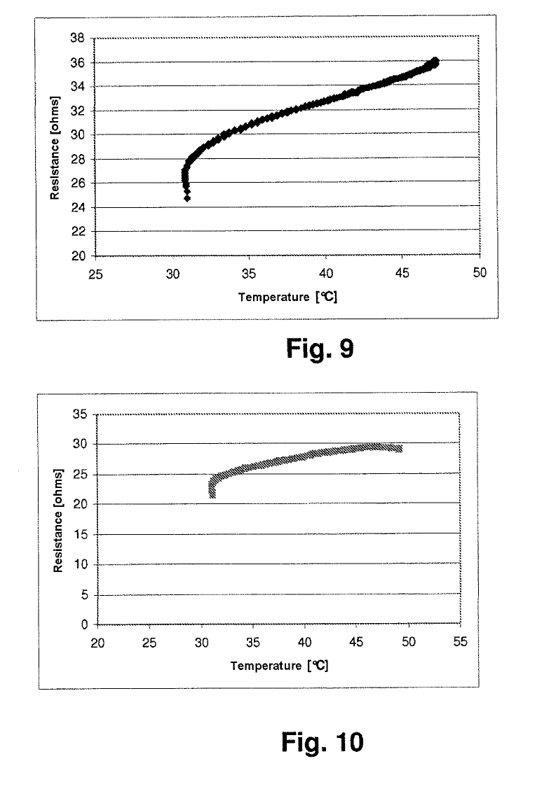

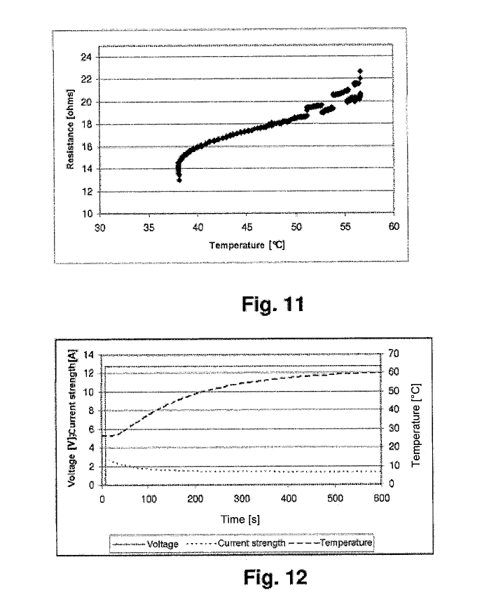

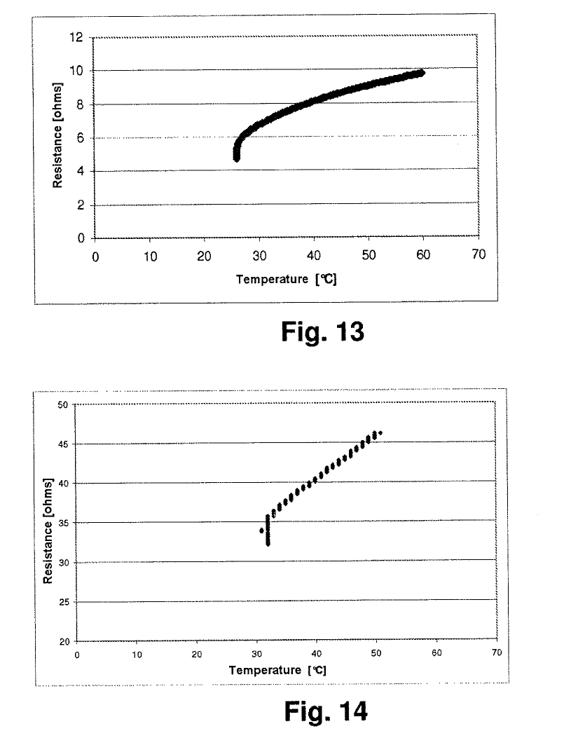

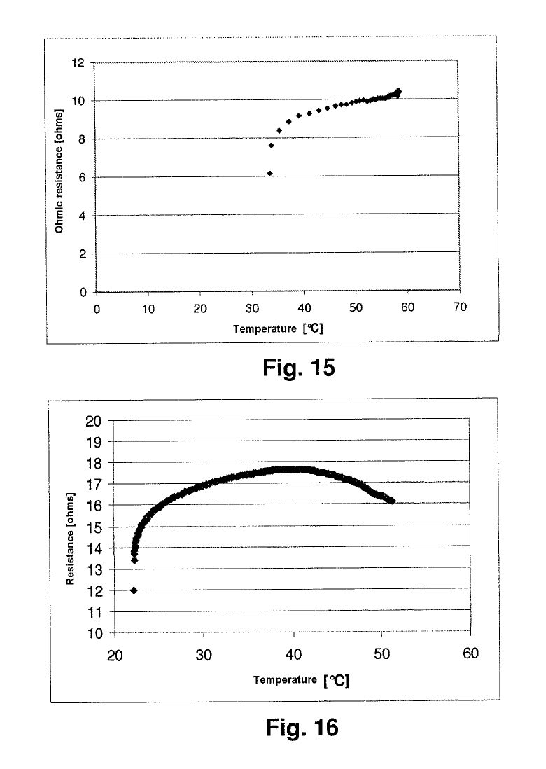

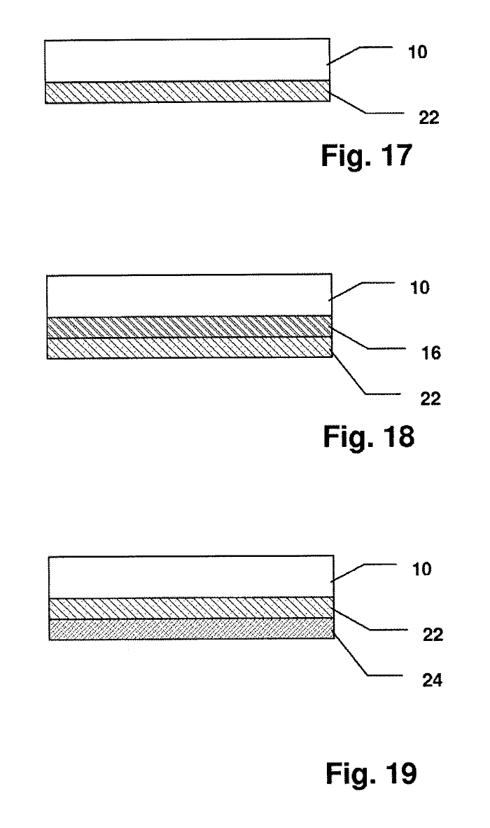

### REFERENCE NUMERALS

10 hotmelt adhesive

12 metal foil

14 metal mesh

16 backing material (e.g., polymeric film)

18 metal layer

20 electrode structure

22 pressure-sensitive adhesive

24 liner material (e.g., release-coated backing material)

1. A planar structure comprising at least one layer of an adhesive within which heat can be generated, wherein the adhesive is a hotmelt adhesive and a posistor.

2. The planar structure of claim 1, wherein the generation of the heat is induced by electrical current flow.

3. The planar structure of claim 1, wherein the at least one layer of the hotmelt adhesive comprises
(a) at least one adhesive component and
(b) at least one electrically conductive material.

4. The planar structure of claim 3, wherein the electrically conductive material is graphite and/or carbon black.

5. The planar structure of claim 3, wherein the at least one electrically conductive material has a mass fraction of 2% to 60% by weight, based on the hotmelt adhesive.

6. The planar structure of claim 3, wherein the electrically conductive material has an extent in at least one spatial direction of not more than 500 nm.

7. The planar structure of claim 6, wherein carbon nanotubes and/or carbon nanofibers are used as electrically conductive material.

8. The planar structure of claim 1, wherein the hotmelt adhesive is one based on partially crystalline polymers, or partially crystalline polymers have been added to the adhesive component.

9. The planar structure of claim 8, wherein the hotmelt adhesive contains at least 30% by weight of partially crystalline polymers.

10. The planar structure of claim 9, wherein the partially crystalline polymers are polyolefins, copolymers of polyolefins, ionomers, polyamides and/or copolymers of polyamides.

11. The planar structure of claim 1, which has at least one electrically conducting contacting means, the contacting means being effectuated optionally by a metal foil, a metal mesh, a metalized polymeric film and/or a metallization of the surface of the hotmelt adhesive.

12. The planar structure of claim 1, wherein the at least one layer of the hotmelt adhesive comprises at least one filler with a high heat capacity.

13. The planar structure of claim 1, which has at least one second layer of a hotmelt adhesive.

14. The planar structure of claim 1, which has at least one further layer composed of a pressure-sensitive adhesive.

15. The planar structure of claim 14, wherein the pressure-sensitive adhesive is one based on acrylic acid and/or methacrylic acid and/or based on esters of the aforementioned compounds, or one based on hydrated natural or synthetic rubber.

16. The planar structure of claim 14, which has at least one liner material.

17. The planar structure of claim 1, which has at least one backing material.

18. The planar structure of claim 1, wherein the heatable planar structure is equipped with a mechanism which when the planar structure is first heated leads to an increase in the cohesion of the hotmelt-adhesive, heatable layer and/or of a further hotmelt adhesive or pressure-sensitive adhesive layer.

19. A method for bonding automobile parts, said method comprising adhering a planar structure to such automobile parts, wherein the planar structure is a planar structure of claim 1.

20. The method of claim 19, which further comprises heating substrates bonded with such planar structures.

21. The method of claim 20, wherein the heating of the substrate is induced by heating of the planar structure, the planar structure having been applied to a base surface which is furnished with at least one electrical contact, the base surface being, optionally, one of the bonded substrates itself.
